(19) United States
(12) Patent Application Publication
(10) Pub. No.: US 2007/0040992 A1
(43) Pub. Date: Feb. 22, 2007

(54) Projection apparatus and control method thereof

(75) Inventor: Sung-min Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/446,215

(22) Filed: Jun. 5, 2006

(30) Foreign Application Priority Data
Aug. 18, 2005 (KR) 2005-0075888

(51) Int. Cl. G03B 21/26

(52) U.S. Cl. 353/34; 353/36

(57) ABSTRACT

A projection apparatus which automatically adjusts a first projection position and a second projection position through a smooth picture technique, and a control method thereof are provided. The projection apparatus includes a screen; an optical engine having a digital micromirror device with diamond-shaped pixels; a smooth picture adjusting module which alternately projects the image from the digital micromirror device to a first projection position and a second projection position spaced from the first projection position by a predetermined interval in a vertical direction; a pattern image generator which generates a pattern image having at least one horizontal line; a pattern image detector which detects a vertical width of the horizontal line; and a controller which controls the smooth picture adjusting module to adjust at least one of the first projection position and the second projection position so that the width of the horizontal line is within a predetermined range.

### CROSS-REFERENCE TO RELATED APPLICATIONS

This application claims priority from Korean Patent Application No. 2005-0075888, filed on Aug. 18, 2005, in the Korean Intellectual Property Office, the disclosure of which is incorporated herein by reference.

### BACKGROUND OF THE INVENTION

1. Field of the Invention

Apparatuses and methods consistent with the present invention relate to a projection apparatus which employs a smooth picture technique using a virtual resolution, and to a control method thereof.

2. Description of the Related Art

Recently, display apparatuses with large screens and high picture quality have been the center of attention, and projection apparatuses such as projection TVs or projectors are suggested as large screen display apparatuses.

Projection apparatuses use optical engines. Optical engines mainly employ cathode ray tubes (CRTs), liquid crystal displays (LCDs), or digital micromirror devices (DMDs).

A DMD optical engine may be used in a digital light processing (DLP) system, and comprises an optical switch display element which changes an angle of a micromirror within a range of about +10° to −10° to convert light reflection angles into 2 modes.

Recently, a DMD element which has diamond-shaped pixels with lowered production costs, has been developed. The diamond-shaped DMD element smoothes a coarse hexagon of a pixel through a smooth picture technique, which utilizes virtual resolution.

The smooth picture technique alternately projects an image from the optical engine to a screen in a first projection position and a second projection position, shifted in a vertical direction by half a pixel, thereby presenting images likely to have a higher resolution.

However, according to a conventional smooth picture technique, a worker will generally adjust the interval between the first projection position and the second projection position with his or her naked eyes when manufacturing the projection apparatus. The worker generally adjusts the interval to be optimal, i.e., to be a half a pixel between the first and second projection positions.

Thus, the interval may be arbitrarily adjusted by a worker, thereby causing differences in the intervals such that post-production projection apparatuses may have different intervals.

External environmental factors such as temperature, humidity, and external shock may distort the interval between the first and second projection positions of the post-production projection apparatus. However, a user may not correct the distorted interval between the first and second projection positions.

### SUMMARY OF THE INVENTION

The present invention to provides a projection apparatus which uses a digital micromirror device (DMD) having diamond-shaped pixels and automatically adjusts an interval between a first projection position and a second projection position through a smooth picture technique, and a control method thereof.

According to an aspect of the present invention, there is provided a projection apparatus which comprises a screen which displays an image thereon; an optical engine comprising a digital micromirror device having diamond-shaped pixels, and a smooth picture adjusting module which projects an image reflected from the digital micromirror device to a first projection position of the screen and a second projection position. The second projection position is spaced form the first projection position by a predetermined interval in a vertical direction. The projection apparatus further comprises a pattern image generator which generates a pattern image having at least one horizontal line; a pattern image detector which detects a vertical width of the horizontal line of the pattern image displayed on the screen by the optical engine; and a controller which controls the smooth picture adjusting module to adjust at least one of the first projection position and the second projection position so that the width of the horizontal line detected by the pattern image detector is within a predetermined range.

According to another aspect of the present invention, the range is from Wₗ to Wₗ+Wₚᵢₓ, inclusive of Wₗ+Wₚᵢₓ, wherein Wₗ is a vertical width of the horizontal line projected to the first projection position, and Wₚᵢₓ is a vertical width of a projection pixel projected to the screen by a single diamond-shaped pixel.

According to another aspect of the present invention, the pattern image comprises a horizontal line at a white level and a background picture at a black level.

According to another aspect of the present invention, the pattern image detector detects the vertical width of the horizontal line based on a brightness of the horizontal line at the white level.

According to another aspect of the present invention, the pattern image detector is disposed on the screen adjacent to the horizontal line when the pattern image is displayed on the screen.

According to another aspect of the present invention, there is provided a method of controlling a projection apparatus which comprises: providing a screen and an optical engine comprising a digital micromirror device, having diamond-shaped pixels, and a smooth picture adjusting module. The method also comprises displaying a pattern image having at least one horizontal line on the screen through the optical engine at a first projection position and a second projection position spaced from the first projection position by a predetermined interval in a vertical direction; detecting a vertical width of the horizontal line of the pattern image displayed on the screen; and adjusting, via the smooth picture adjusting module, at least one of the first projection position and the second projection position so that a width of the horizontal line detected by the pattern image falls within a predetermined range.

According to another aspect of the present invention, the range is from Wₗ to Wₗ+Wₚᵢₓ, inclusive of Wₗ+Wₚᵢₓ, wherein Wₗ is a vertical width of the horizontal line projected to the first projection position, and Wₚᵢₓ is a vertical width of a projection pixel projected to the screen by a single diamond-shaped pixel.

According to another aspect of the present invention, the displaying the pattern image on the screen comprises displaying the pattern image having a horizontal line at a white level and a background picture at a black level.

### BRIEF DESCRIPTION OF THE DRAWINGS

The above and/or other aspects of the present invention will become apparent and more readily appreciated from the following description of the exemplary embodiments, taken in conjunction with the accompanying drawings of which:

FIG. 1 is a control block diagram of a projection apparatus according to an exemplary embodiment of the present invention;

FIG. 2 illustrates an optical engine of the projection apparatus in FIG. 1 according to an exemplary embodiment of the present invention;

FIG. 3 illustrates an SP adjusting module of the projection apparatus in FIG. 1 according to an exemplary embodiment of the present invention;

FIG. 4A illustrates a part of an exemplary horizontal pattern displayed on a first projection position;

FIG. 4B illustrates a part of an exemplary horizontal pattern displayed on a second projection position;

FIG. 5 illustrates an exemplary virtual pattern image which is generated by the pattern images of FIG. 4A and FIG. 4B when the interval between the first and second projection positions is spaced to a half of the diamond-shaped pixel;

FIG. 6 illustrates an exemplary pattern image projected on a screen; and

FIG. 7 illustrates an exemplary method of controlling a projection apparatus.

### DETAILED DESCRIPTION OF EXEMPLARY EMBODIMENTS OF THE INVENTION

Reference will now be made in detail to exemplary embodiments of the present invention, examples of which are illustrated in the accompanying drawings, wherein like reference numerals refer to like elements throughout.

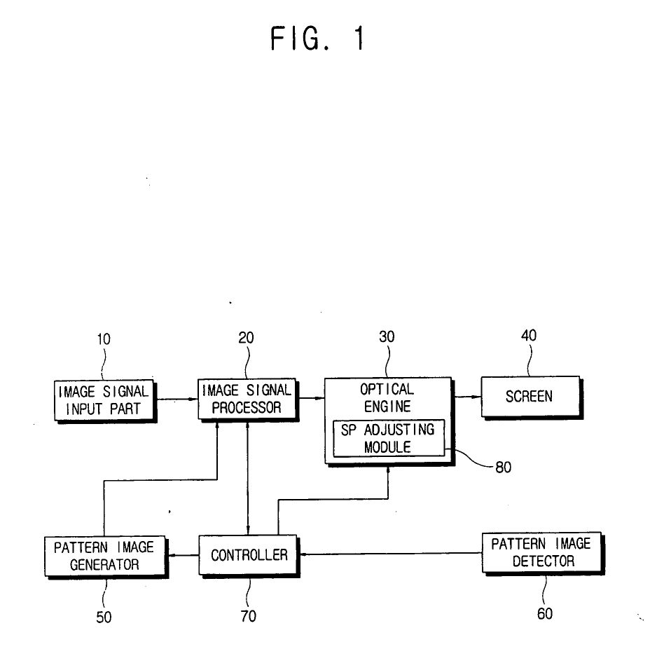

As shown in FIG. 1, a projection apparatus according to the present invention comprises an image signal input part 10, an image signal processor 20, an optical engine 30, a screen 40, a pattern image generator 50, a pattern image detector 60, and a controller 70.

The image signal input part 10 receives an image signal supplied from an image signal source such as a computer or a broadcasting station. The image signal input through the image signal input part 10 may have various formats. For example, the image signal received through the image signal input part 10 may comprise a broadcasting signal received through an antenna or a tuner; an image signal of a composite video baseband signal (CVBS), an S-video type image signal; an analog RGB image signal received through a D-Sub connector connected to a computer or a digital image signal of a digital video interface; or a component type image signal.

The image signal processor 20 converts the image signal received through the image signal input part 10 into a format processible by the optical engine 30 and outputs the converted signal. The image signal processor 20 may comprise an A/D converter and a scaler to convert the analog image signal input through the image signal input part 10 into a digital image signal.

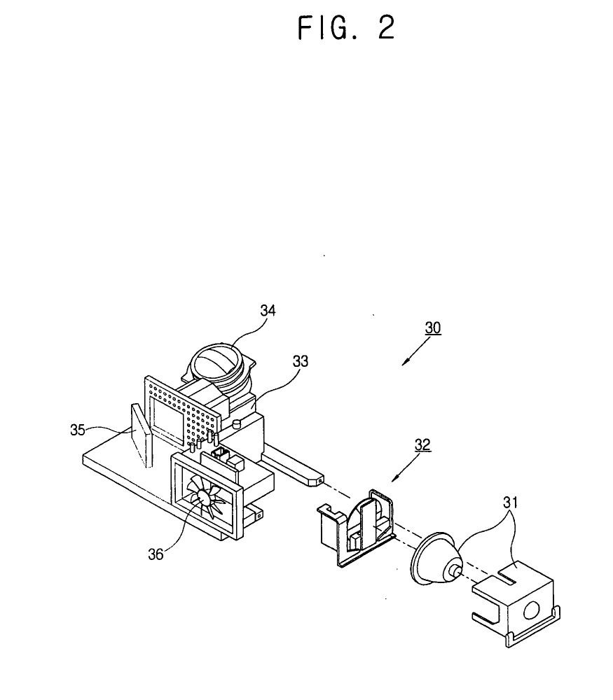

The optical engine 30, illustrated in FIG. 2, comprises a DMD having diamond-shaped pixels. Also, the optical engine 30 comprises an SP adjusting module 80 to realize a smooth picture technique as a virtual resolution technique, through the DMD 35 with the diamond-shaped pixels.

Here, the SP adjusting module 80 realizes the smooth picture technique by alternately projecting an image reflected from the DMD 35 to a first projection position and a second projection position of the screen 40. The first projection position is spaced from the second projection position in a vertical direction.

The optical engine 30 may comprise a light source 31 of a DLP type; a color wheel unit 32 to selectively filter a light emitted from the light source 31; a DMD 35 to adjust a reflection angle of the light passing through the color wheel unit 32 and to form the image; and an image projector 34 to project the image formed by the DMD 35 to the screen 40. The optical engine 30 may further comprise an optical part 33 which is provided between the light source 31 and the color wheel unit 32, or between the color wheel unit 32 and the DMD 35 to make the light uniform; and a cooling fan 36 to cool down the light source 31 and the color wheel unit 32.

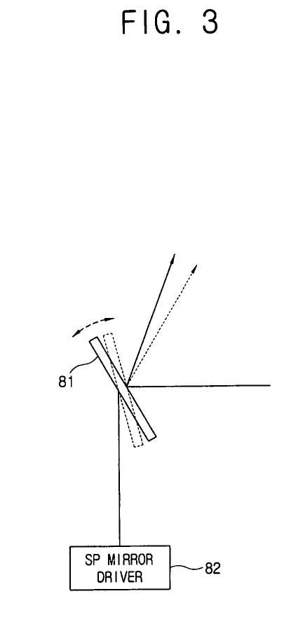

Here, the SP adjusting module 80 may be provided in the image projector 34. Referring to FIG. 3, the SP adjusting module 80 may comprise an SP mirror 81 to selectively project the image reflected from the DMD 35 to the first projection position and the second projection position of the screen 40; and an SP mirror driver 82 which rotates the SP mirror 81 to selectively project the image reflected from the DMD 35 to the first projection position and the second projection position of the screen 40.

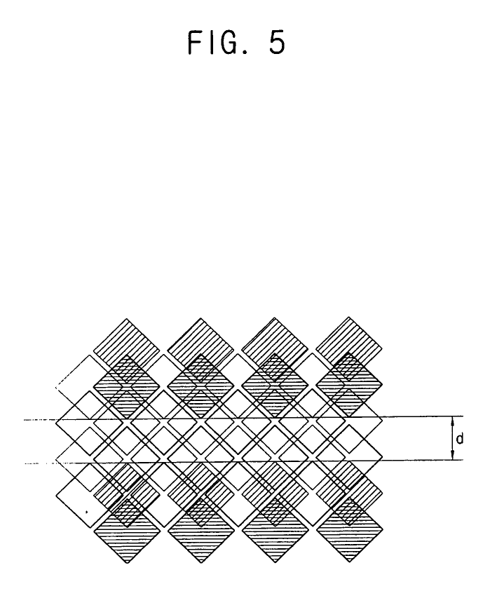

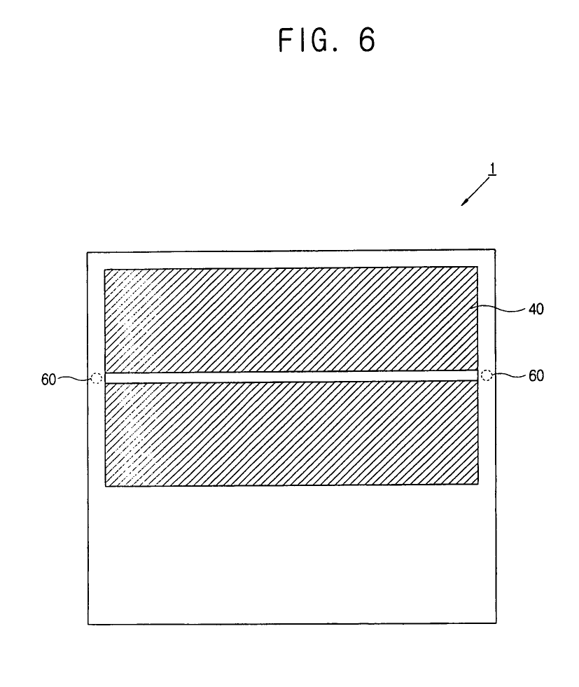

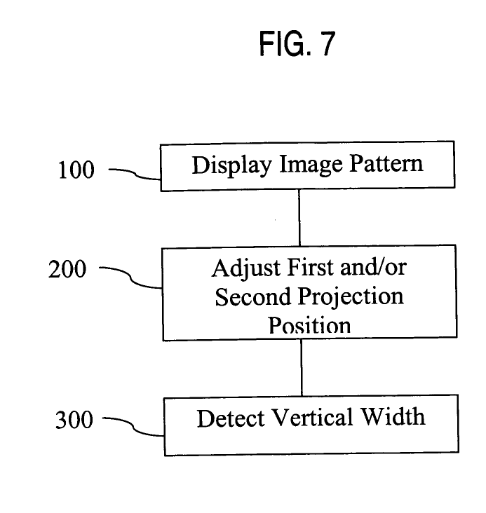

Referring to FIG. 7, the pattern image generator 50 generates a pattern image having at least one horizontal line. Here, the pattern image generated by the pattern image generator 50 is displayed on the screen 40 through the image signal processor 20 and the optical engine 30 (operation 100). As shown in FIGS. 5 and 6, an exemplary pattern image according to the present invention comprises a horizontal line at a white level and a background picture at a black level.

The pattern image detector 60 detects a vertical width “d” of the horizontal line of the pattern image displayed on the screen 40 (operation 200). The pattern image detector 60 provides information on the vertical width d of the detected horizontal line to the controller 70.

As shown in FIG. 6, the pattern image detector 60 may be provided in a position corresponding to where the horizontal line of the pattern is displayed on the screen 40. The pattern image detector 60 comprises a light sensor which detects light, thereby detecting the horizontal line at the light level and the vertical width “d” of the horizontal line.

The controller 70 controls the SP adjusting module 80 to make the width of the horizontal line detected by the pattern image detector 60 be included in a range of a predetermined reference width (operation 300). For example, the controller 70 controls the SP mirror driver 82 of the SP adjusting module 80 to adjust at least one of the first projection position and the second projection position. Accordingly, the vertical width “d” of the horizontal line of the pattern image displayed on the screen 40 may be adjusted.

The reference width range may satisfy Formula 1 as follows:
Wₗ<W_{ref}≦Wₗ+Wₚᵢₓ [Formula 1]

Here, W_{ref} refers to the reference width, Wₗ is the vertical width of the horizontal line projected on the first projection position (or the second projection position), and Wₚᵢₓ means a vertical width d of a projection pixel projected to the screen 40 by a single diamond-shaped pixel.

According to Formula 1, the interval between the first projection position and the second projection position in the vertical direction may be a half of the vertical width of the projection pixel projected to the screen 40 by the single diamond-shaped pixel.

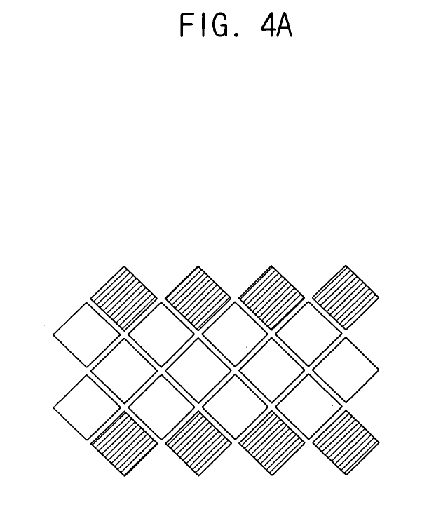

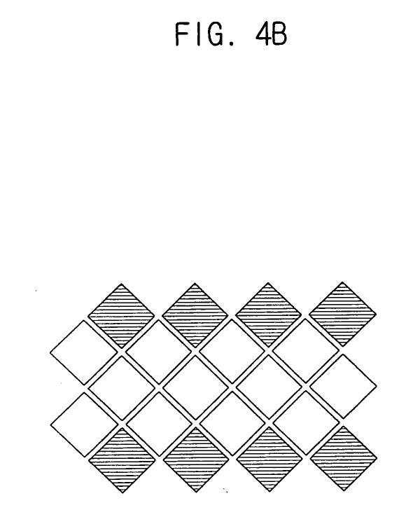

FIG. 4A illustrates a part of the horizontal line of the pattern image displayed on the first projection position, and FIG. 4B is a part of the horizontal line of the pattern image displayed on the second projection position.

FIG. 5 illustrates a virtual pattern image which is generated by the pattern images of FIG. 4A and FIG. 4B when the interval between the first and second projection positions is spaced to a half of the diamond-shaped pixel.

Thus, the controller 70 controls the SP adjusting module 80 to make the first projection position and the second projection position generate the image as shown in FIG. 5, based on a detection result of the pattern image detector 60.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A projection apparatus comprising:
a screen which displays an image;
an optical engine comprising:
a digital micromirror device having diamond-shaped pixels, and
a smooth picture adjusting module which alternately projects an image reflected from the digital micromirror device to a first projection position of the screen and to a second projection position spaced from the first projection position by a predetermined interval in a vertical direction;
a pattern image generator which generates a pattern image having at least one horizontal line;
a pattern image detector which detects a vertical width of the horizontal line of the pattern image displayed on the screen by the optical engine; and
a controller which controls the smooth picture adjusting module to adjust at least one of the first projection position and the second projection position so that a width of the horizontal line detected by the pattern image detector is within a predetermined range.

2. The apparatus according to claim 1, wherein the predetermined range is greater than Wₗ and less than or equal to Wₗ+Wₚᵢₓ, wherein Wₗ is a vertical width of the horizontal line projected to the first projection position, and Wₚᵢₓ is a vertical width of a projection pixel projected to the screen by a single diamond-shaped pixel.

3. The apparatus according to claim 2, wherein the pattern image comprises a horizontal line at a white level and a background picture at a black level.

4. The apparatus according to claim 3, wherein the pattern image detector detects the vertical width of the horizontal line based on a brightness of the horizontal line at the white level.

5. The apparatus according to claim 1, wherein the pattern image detector is disposed on the screen adjacent to the horizontal line of the pattern image displayed on the screen.

6. The apparatus according to claim 1, wherein the pattern image comprises a horizontal line at a white level and a background picture at a black level.

7. A method of controlling a projection apparatus, the method comprising:
a displaying a pattern image having at least one horizontal line on a screen of the projection apparatus at a first projection position and a second projection position spaced from the first projection position by a predetermined interval in a vertical direction;
detecting a vertical width of the horizontal line of the pattern image displayed on the screen; and
adjusting at least one of the first projection position and the second projection position so that a width of the horizontal line detected by the pattern image falls within a predetermined range.

8. The method according to claim 7, wherein the predetermined range is greater than Wₗ and less than or equal to Wₗ+Wₚᵢₓ, wherein Wₗ is a vertical width of the horizontal line projected to the first projection position, and Wpix is a vertical width of a projection pixel projected to the screen by a single diamond-shaped pixel.

9. The method according to claim 7, wherein the displaying the pattern image on the screen comprises displaying the pattern image having a horizontal line at a white level and a background picture at a black level.

10. The method according to claim 7, wherein the projection apparatus comprises an optical engine comprising a digital micromirror device, having diamond-shaped pixels, and a smooth picture adjusting module, which alternately projects an image reflected from the digital micromirror device to the first projection position and the second projection position; and
the adjusting at least one of the first projection position and the second projection position is performed via the smooth picture adjusting module.
